(19) United States
(12) Patent Application Publication
(10) Pub. No.: US 2004/0035050 A1
(43) Pub. Date: Feb. 26, 2004

(54) Decorative flower pot sleeve

(76) Inventor: Sallie McLarty, Greensboro, NC (US)

Correspondence Address: WOMBLE CARLYLE SANDRIDGE & RICE PLLC, 300 N. GREENE STREET, SUITE 1900, GREENSBORO, NC, 27401, US

(21) Appl. No.: 10/227,280

(22) Filed: Aug. 23, 2002

(51) Int. Cl. A01G 9/02

(52) U.S. Cl. 47/72

(57) ABSTRACT

A decorative support sleeve for a flower pot is disclosed. The sleeve is configured to support a flower pot on a substantially flat surface such that no portion of the flower pot directly contacts the substantially flat surface. Also, no portion of the sleeve directly contacts a bottom surface of the flower pot. The sleeve may include a shell portion configured to substantially surround and support an outer surface of the flower pot. The shell portion includes a lower edge and a substantially open bottom. A plurality of spaced feet downwardly extend from the lower edge of the shell portion. The feet are configured to elevate a flower pot in the sleeve above a substantially flat surface. Another embodiment includes a plurality of ears or tabs for suspending the sleeve from an elevated support.

### BACKGROUND

1. Field of the Invention

The invention generally relates to sleeves for pots for flowers or other plants, and more particularly relates to a decorative sleeves for pots for plants which also elevate the pots supported therein above an underlying supporting surface.

2. Description of the Prior Art

Flower pots are used to contain and display flowers and other plants both indoors and outdoors. Such pots are available in a wide variety of sizes and shapes. A common form of pot for plants includes an outer wall having an inverted frusto-conical shape, a round open top, and a substantially flat bottom. Such pots may be constructed of terracotta or other ceramic materials, or may be constructed of plastic, polyvinyl chloride (PVC), or the like. Because excess water must preferably be drained from these pots to prevent harming the plants contained therein, these pots typically include one or more drainage openings in their substantially flat bottoms. Excess water in the pots drains through soil in the pots to the bottom of the pots, and is free to exit from the pots through these drainage openings.

Though such pots may include decorative patterns on their exterior surfaces, many commonly used pots have a simple, plain exterior which is not particularly attractive. In order to enhance the outer appearance of these pots, it is known to place a decorative sleeve around the outside of the pots. Such decorative sleeves are typically constructed of flexible material such as paper, foil, Mylar, flexible plastic, or the like. Often such flexible decorative sleeves are secured to the pots by ribbons or bands of some sort. The sole function of such decorative sleeves is to improve the outer appearance of flower pots. Such decorative sleeves do not elevate or otherwise substantially support the pots in any way. Decorative sleeves of this type which cover both the sides and the bottoms of pots may prevent proper drainage from the drainage openings in the pots, thereby causing excess water to accumulate in the pots and potentially causing damage to the flowers or other plants in the pots.

While drainage openings in the bottoms of pots for flowers or plants may be beneficial to potted plants, drainage from these openings can be problematic. For example, when such pots are placed directly on a flat support surface, the weight of the pots and the plants and soil therein may prevent excess water from escaping through the drainage openings in the bottoms of the pots. Rather, draining water may become entrapped between the bottoms of the pots and the underlying support surfaces. This entrapped water may block additional excess water in the pots from freely draining from the pots, thereby causing damage to the potted plants therein. Furthermore, when these pots are supported on surfaces which are sensitive to water such as wooden tabletops, the accumulated water may stain or otherwise damage such surfaces. Also, because the bottoms of the pots may substantially shield the accumulated water from surrounding ambient air, evaporation of discharged water may be inhibited. The water may remain puddled on a sensitive underlying surfaces for extended periods of time, thereby increasing the potential for water damage to the support surfaces. Also, water trapped under these pots may be shielded from view by the pots themselves, thereby preventing detection until after damage has already occurred.

One solution to the problem of excess drainage from potted plants is to place saucers under the pots to capture any draining water. Though such saucers may be sufficient to prevent draining water from reaching or accumulating atop a sensitive support surface, the drainage from these pots may be sufficient to overflow their saucers. Because it may take several minutes for excess water to actually pass from newly watered potted plants, persons watering such plants may be unaware that an overflow is about to occur. Further, an overflow may occur well after a person has left the surrounding area. Overflowing water may seep between bottom surfaces of these saucers and sensitive underlying support surfaces, and such water may stagnate and eventually damage these surfaces. Like the pots, the saucers may actually inhibit desired drainage and the evaporation of accumulated water, and may shield accumulated spillage from detection. Also, such saucers do little to enhance the appearance of a flower pot.

Therefore, there is a need for a decorative sleeve for pots for flowers or other plants which not only provides an enhanced outer appearance to such pots, but which also addresses the above-mentioned problems resulting from water drainage from such pots. Such a decorative sleeve should permit excess water to freely drain from drainage openings in the pots, and also should prevent drainage water from becoming inconspicuously trapped beneath a pot. Further, such a sleeve should be compatible for use in combination with conventional drainage saucers.

### SUMMARY OF THE INVENTION

A decorative sleeve for a flower pot is provided. The sleeve is preferably configured to closely envelope an outer surface of a flower pot, and provides a decorative pattern or appearance about at least a portion of an outer surface of the pot. The sleeve also provides a stable support for the flower pot. The sleeve includes a lower edge and/or plurality of feet which extend below the base of the flower pot and provide a stable base for supporting the pot. The sleeve elevates the base of the pot therein above an underlying support surface, thereby permitting free drainage from one or more drainage openings in the base of the flower pot. The sleeve also makes the underlying support surface and any water accumulated on this surface visible, so that drainage from the pot can readily be detected.

The sleeve is designed to receive a flower pot having an outer wall and a substantially flat bottom. The sleeve is configured to substantially surround the outer wall of the flower pot and to vertically support the flower pot on a substantially flat support surface such that there is no contact between the sleeve and the bottom surface of the flower pot. Accordingly, no portion of the flower pot supported in the sleeve contacts the substantially flat support surface.

The sleeve may include a shell portion configured to substantially surround and support an outer surface of the flower pot. The shell portion may be configured to surround and support a flower pot having an inverted frusto-conical outer shape and an outer diameter. In this arrangement, the sleeve may include a substantially matching frusto-conical shape and an inner diameter which is less than or equal to the outer diameter of the pot. The shell portion includes a lower edge which may include a plurality of spaced feet downwardly extending from the lower edge. The feet are configured to prevent any portion of the flower pot from contacting a substantially flat surface when the flower pot is supported in the sleeve. The plurality of feet may include three or more feet in a number suitable for supporting a pot on a substantially flat surface. In one arrangement, the feet have a substantially arcuate shape.

The invention also provides a decorative flower pot sleeve for suspending a pot from an elevated support. In this arrangement, the shell may further include an upper edge and a plurality of ears or tabs proximate the upper edge. Lower ends of a plurality of elongated hanging members such as chains, cords, or the like may be connected to the ears or tabs for suspending the sleeve from the elevated support. Because it is desirable that the ears or tabs do not interfere with a pot supported in the sleeve or a plant therein, the ears or tabs may extend substantially upwardly and substantially outwardly from the upper edge of the shell.

The sleeve may be substantially formed from a single continuous sheet of material. Preferably, the sheet of material is selected from a group consisting of steel, tin, aluminum, copper, brass, bronze, plastic, vinyl, and polyvinyl chloride. In order to provide a decorative appearance, the shell portion may include a plurality of decorative cutouts and edges forming a decorative shape or pattern. The sleeve may be sized and shaped to support a conventional round flower pot having a frusto-conical outer surface. The sleeve may have a matching frusto-conical shape with an inner diameter that is smaller than a corresponding outer diameter of the round pot. This smaller diameter causes the bottom of the flower pot to be suspended in the sleeve such that no portion of the pot contacts an underlying substantially flat support surface. In one embodiment, the sleeve may be formed in a single seamless piece, such as by casting or molding. At least a portion of a surface of the sleeve may include a protective or decorative coating or finish such as paint, glazing, plating, or the like. At least a portion of a surface of the sleeve may include a painted design thereon.

A method is also provided for producing a sleeve for a flower pot having an outer wall and a bottom surface. The method includes first cutting a blank from a single sheet of material. The sheet of material may be metal or any other suitable material. The blank may be cut by stamping, punching, laser-cutting, machining, abrasive cutting, or any other suitable cutting method. Also, the blank may be cut such that the blank includes one or more decorative cutouts to form a decorative pattern or shape. Also, the blank may have a substantially arcuate shape so that it can be formed into a frusto-conical shape for supporting a conventional round flower pot. Further, the blank may include a plurality of feet configured to support the pot on a substantially flat surface. Next, the blank is formed into a sleeve which substantially conforms to a shape of at least a portion of the outer surface of the flower pot. For example, for use with conventional round flower pots having a frusto-conical outer wall, at least a portion of the sleeve is similarly shaped to form a frustum. Finally the sleeve is fixed in a formed state. Where the sleeve includes a seam, seamed edges may be fixed together by welding, soldering, brazing, gluing, riveting, or any other suitable fixing method. The method may also include applying a decorative or protective finish, coating, or painted design to at least a portion of a surface of the sleeve.

The sleeve produced by the above process is configured to envelope and support at least a portion of the outer surface of the flower pot such that no portion of the sleeve contacts the bottom surface of the pot. The sleeve is also configured to support the pot on a substantially flat surface such that no portion of the flower pot directly contacts the substantially flat surface.

These and other aspects of the invention will be made clear from a reading of the following detailed description together with the drawings.

### BRIEF DESCRIPTION OF THE DRAWINGS

FIG. 1 is a perspective view of a flower pot supported in a decorative flower pot sleeve according to the present invention;

FIG. 2 is a perspective view of the flower pot sleeve shown in FIG. 1;

FIG. 3 is a view of a blank for forming the sleeve shown in FIGS. 1 and 2;

FIG. 4A is an elevation view of a detail of a connection between end edges of the blank of FIG. 3 as viewed from the outside of the sleeve;

FIG. 4B is an elevation view of the connection shown in FIG. 4A as viewed from the inside of the sleeve;

FIG. 5 is a cross-sectional view taken though the center of the flower pot and sleeve shown in FIG. 1; and

FIG. 6 is a perspective view of another embodiment of a decorative flower pot sleeve.

### DETAILED DESCRIPTION

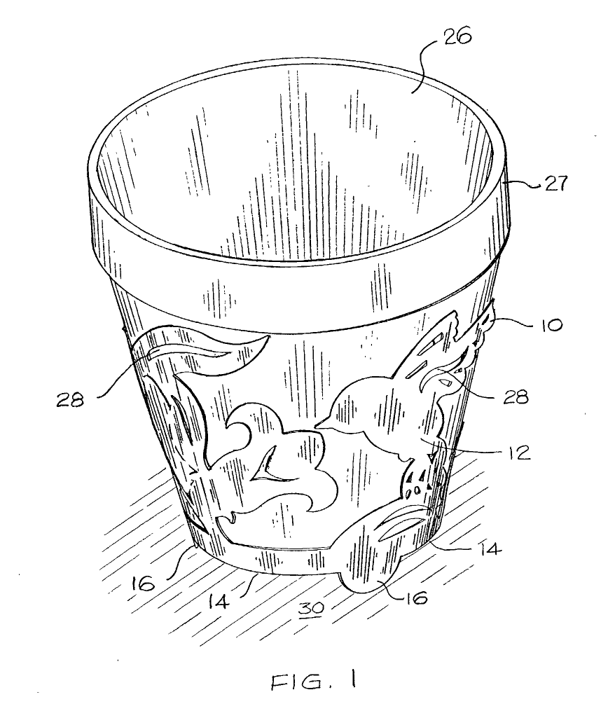

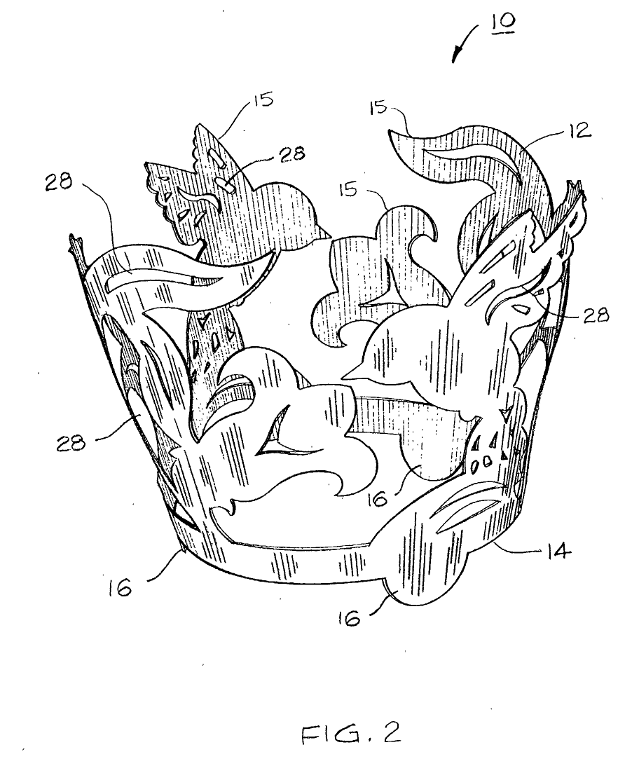

FIGS. 1 and 2 show a decorative flower pot sleeve 10 according to the present invention. As shown in FIG. 2, the sleeve 10 includes a shell 12 having a lower edge 14. The shell 12 may include a substantially frusto-conical shape and a substantially open bottom. A frusto-conical shape corresponds to the outer shape of a conventional round flower pot 26 similar to that shown in FIG. 1. Alternatively, the shell 14 may have other shapes corresponding to other outer shapes of floor pots such as substantially frusto-pyramidal, cubic or other rectilinear shapes, or the like. Additionally, the sleeve 10 may be sized to correspond to any size of flower pot 26. When the sleeve 10 has a frusto-conical shape as illustrated in FIGS. 1 and 2 or another nestable shape, a plurality of sleeves 10 can be nested together in telescoping arrangement for compact storage or shipment (not shown).

As shown in FIG. 2, the sleeve 10 may include a plurality of feet 16 in spaced arrangement along the lower edge 14 of the shell 12. The feet 16 stably support the sleeve 10 and a pot 26 therein on a substantially flat support surface 30. When feet 16 are provided on the lower edge 14, the sleeve 10 should include at least three feet 16, but may include four or more feet 16. The feet 16 may have an arcuate shape as shown, or any other suitable shape for providing a stable base for the sleeve 10. Alternatively, the lower edge 14 may be configured to sit directly on the substantially flat surface 30 (not shown), so long as the sleeve 10 elevates every portion of a pot therein above the supporting surface 30.

The shell 12 may include a plurality of cutouts 28 to impart a decorative appearance to the sleeve 10. Also, other edges 15 of the shell 10 may be shaped to further enhance the appearance of the sleeve 10. For example, the embodiment of the sleeve shown in FIGS. 1-4 includes outer edges 15 and cutouts 28 which combine to form silhouettes of birds and flowers. The sleeve 10 may include any other desired shapes of decorative edges 15 and/or cutouts 28.

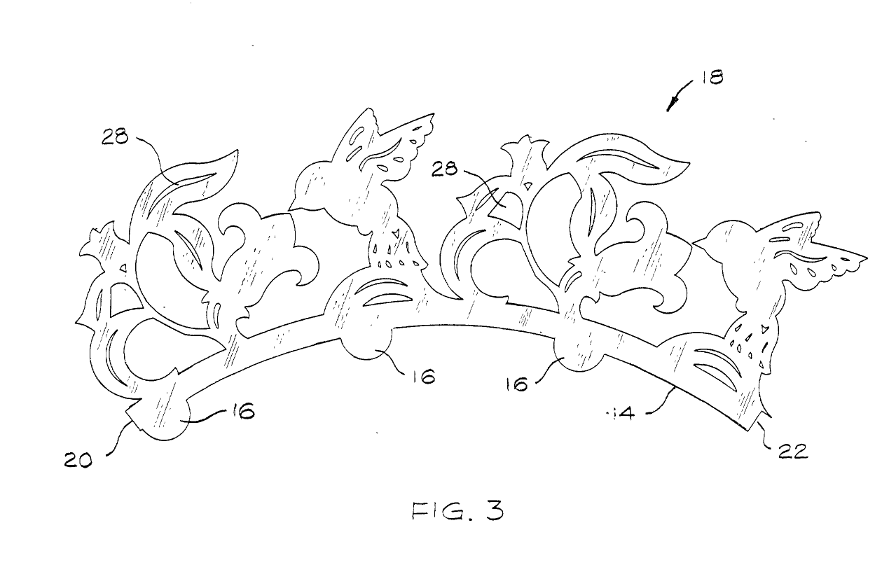

The sleeve 10 may be constructed of any material that is sufficiently rigid in a formed state to support a pot 26 in the sleeve 10. For example, the sleeve may be constructed of tin, steel, aluminum, brass, bronze, copper, plastic, polyvinyl chloride, or the like. In a preferred construction, the sleeve 10 is substantially constructed from a single sheet of material. FIG. 3 shows a blank 18 formed in an arcuate shape from a single sheet of thin material such as metal, plastic, or the like, for forming a sleeve 10 having a frusto-conical shape as shown in FIGS. 1 and 2. When metal is used, the blank 18 may have a thickness of about 0.5 mm. Thinner or thicker blanks 18 may be used depending on the material used and the size of the pot to be received in the sleeve 10. The blank 18 is configured to be formed such as by rolling or bending to provide a shell 14 for receiving a flower pot. The blank 18 may be cut from a sheet of material by stamping, punching, laser cutting, abrasive cutting, machining, or the like.

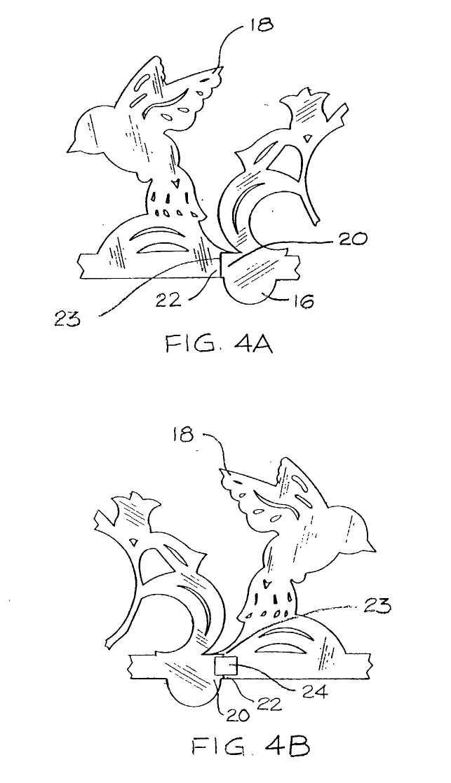

Looking at FIG. 3, the blank 18 includes a first end edge 20 and an opposed second end edge 22. Once the blank 18 is shaped to form a sleeve having the desired shape, the first end edge 20 and second end edge 22 are connected together as shown in FIGS. 4A and 4B, thereby forming a seam 23. The end edges 20, 22 may be affixed to each other by any suitable means, such as by welding, soldering, brazing, gluing, or the like.

In a preferred arrangement shown in FIG. 4B, a backing strip 24 is positioned across the seam 23 and between the end edges 20, 22 on an inside surface of the sleeve 10. Backing strip 24 is affixed to the abutting end edge portions 20, 22, thereby securing the sleeve together along the seam 23. When a backing strip 24 is used, the end edges 20, 22 may be affixed together by the methods described above, or may alternatively be spot welded, riveted, or otherwise permanently joined. Alternatively, the end edges 20, 22 may be overlapped and affixed together in an overlapping arrangement (not shown). The outer surface is then sanded, flushed, or otherwise smoothed to provide a finished outer appearance at the seam 23 like that shown in FIG. 4A. In an alternative construction (not shown), the sleeve 10 may be cast or molded in a single seamless piece using known methods.

One or more protective and/or decorative coatings or finishes may be applied to the sleeve 10. For example, surfaces of the sleeve 10 may be painted, glazed, plated, or the like.

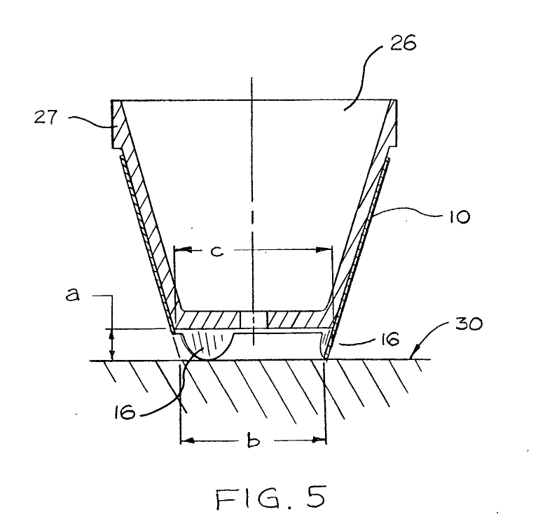

As shown in FIGS. 1 and 5, the sleeve 10 is configured to support a pot 26 on a substantially flat surface 30 such that no portion of the pot 26 contacts the flat surface 30. As shown in FIG. 5, the sleeve 10 supports the pot 26 such that a vertical gap “a” exists between the underlying surface 30 and the bottom of the pot 26. This vertical gap permits water to drain freely from one or more drainage openings 25 in the bottom of pot 26. The vertical gap also permits water draining from the pot 26 to be readily visible to a person viewing the pot 26 and surface 30, and also exposes any water puddled under the pot 26 to the ambient air, thereby facilitating evaporation of the puddled water.

As shown in FIG. 5, a lower portion of the frusto-conical sleeve 10 includes an inner diameter “b” which is less than a minimum diameter “c” of the frusto-conical pot 26. This smaller diameter “b” prevents the frusto-conically shaped pot 26 from dropping below a desired elevation in the sleeve 10, thereby maintaining a desired vertical gap “a”. In other words, as long diameter “b” of sleeve 10 is less than the minimum outer diameter “c” of pot 26, bottom portions of the pot 26 are desirably suspended above the support surface 30 by the sleeve 10 when the pot 26 is fully seated in the sleeve 10.

Conventional round pots, like pot 26 shown in FIGS. 1 and 5, typically include cylindrical or rounded rims 27 along there upper edges. The height of shell 12 is preferably sized such that all portions of the shell 12 fall below the rim 27 when the pot 26 is fully seated in the sleeve 10.

The shell 12 of the sleeve 10 is preferably thin such that the sleeve does not substantially alter the outer profile of a pot 26 positioned in the sleeve 10. The embodiment of the sleeve 10 shown in FIGS. 1 and 2, for example, permits a pot 26 and engaged sleeve 10 to be placed together in a typical drainage saucer of a size suited for such a pot (not shown).

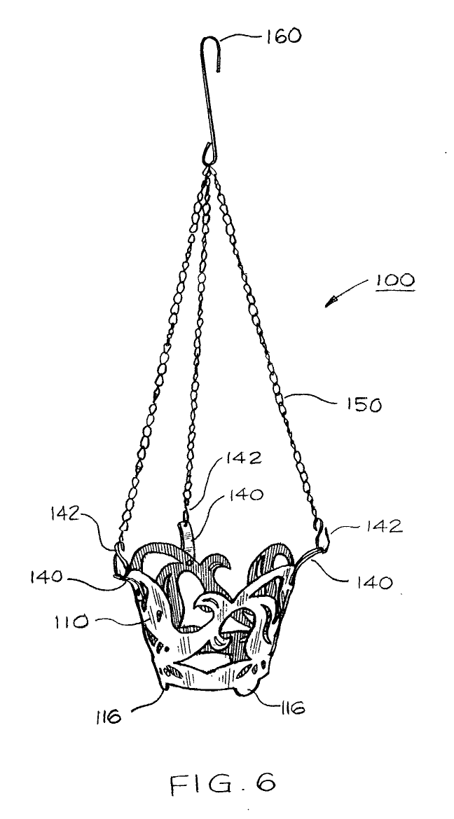

Another embodiment 100 of the decorative flower pot sleeve is shown in FIG. 6. This alternate embodiment 100 includes a decorative sleeve 110 which is substantially the same as the sleeve 10 described above, but is designed such that the sleeve 110 can to be suspended from an elevated support. A plurality of tabs or ears 140 are attached to upper portions of the sleeve 110. Lower ends of a plurality of elongated chains, cords, or the like 150 are connected to the ears 140 by a plurality of S-hooks 142 which engage holes in the ears 140. Upper ends of the chains 150 are connected together by a hanger 160. The ears 140 preferably extend upwardly and outwardly from upper portions of the sleeve 110 as shown in FIG. 6 so that the ears 140 and chains 150 will not interfere with a pot supported in the sleeve or a plant contained therein (not shown). The ears 140 may be connected to the sleeve in any suitable manner, such as by rivets, spot welds, other welds, or the like. Though the decorative sleeve 100 is designed to be suspended from an elevated support, the sleeve portion 110 may include a plurality of feet 116 as shown in FIG. 6. Accordingly, the S-hooks 142 can be disengaged from the ears 140 and the flower pot sleeve 110 can be used to support a flower pot 26 on a horizontal surface 30 in a manner similar to sleeve 10 as shown in FIG. 1

While this invention has been illustrated and described in accordance with a preferred embodiment, it is recognized that variations and changes may be made therein without departing from the invention as set forth in the claims. Certain modifications and improvements will occur to those skilled in the art upon a reading of the forgoing description. For example, while the illustrated embodiment has a substantially frusto-conical shape from top to bottom, the sleeve may include a frusto-conical upper portion for supporting a pot having a matching frusto-conical shape, and one or more non-frusto-conical portions. Alternatively, the sleeve may have a substantially frusto-pyramidal shape, for example, for supporting pots having a similar shape. The sleeve may also have other shapes suited for supporting flower pots having other corresponding shapes so long as the sleeve is configured to support a pot in an elevated position above a flat support surface in a manner as described above. It should be understood that all such modifications are not contained herein for the sake of conciseness and readability, but are properly within the scope of the following claims.

What is claimed is:

1. A sleeve for a flower pot having an outer wall and a bottom surface, wherein the sleeve is configured to substantially surround the outer wall of the flower pot and to vertically support the flower pot on a substantially flat support surface such that there is substantially no contact between the sleeve and the bottom surface of the flower pot and no portion of the flower pot contacts the substantially flat support surface when the flower pot is so supported in the sleeve.

2. A sleeve according to claim 1 for a flower pot having an inverted frusto-conical outer shape and a minimum outer diameter proximate the bottom surface of the flower pot, wherein the sleeve includes a substantially matching frusto-conical shape and an inner diameter which is less than the minimum outer diameter of the pot.

3. A sleeve for a flower pot according to claim 1, the sleeve comprising:
(a) a shell portion configured to substantially surround and support an outer surface of the flower pot, the shell portion having a lower edge and a substantially open bottom; and
(b) a plurality of spaced feet downwardly extending from the lower edge of the shell portion;
wherein the feet elevate the shell portion and a flower pot therein above a substantially flat surface when the flower pot is supported on the substantially flat surface by the sleeve.

4. A sleeve for a flower pot according to claim 3, wherein at least a portion of the shell portion has a substantially frusto-conical shape.

5. A sleeve for a flower pot according to claim 3, wherein the shell portion includes a plurality of decorative cutouts therein.

6. A sleeve for a flower pot according to claim 3, wherein the plurality of feet includes at least three feet.

7. A sleeve for a flower pot according to claim 3, wherein the feet have a substantially arcuate shape.

8. A sleeve for a flower pot according to claim 3, wherein the shell further includes an upper edge and a plurality of ears or tabs substantially proximate to the upper edge, and the sleeve further comprising a plurality of elongated hanging members having lower ends connected to the ears or tabs for suspending the sleeve from an elevated support:

9. A sleeve for a flower pot according to claim 3 wherein the ears or tabs extend substantially upwardly and substantially outwardly from the upper edge of the shell.

10. A sleeve for a flower pot according to claim 1, wherein the sleeve has a shape whereby the sleeve can be nested in telescoping arrangement with one or more similarly shaped sleeves.

11. A sleeve for a flower pot according to claim 1, wherein the sleeve is substantially formed from a single sheet of material.

12. A sleeve for a flower pot according to claim 11, wherein the single sheet of material is selected from a group consisting of steel, tin, aluminum, copper, brass, bronze, plastic, vinyl, and polyvinyl chloride.

13. A sleeve for a flower pot according to claim 11, wherein the single sheet includes opposite end edges which are joined together to form the sleeve.

14. A sleeve for a flower pot according to claim 1, wherein the sleeve is molded or cast in a single substantially seamless piece.

15. A sleeve for a flower pot according to claim 1, wherein at least a portion of the sleeve includes a protective or decorative coating or finish.

16. A method of producing a sleeve for a flower pot, the flower pot having an outer surface and a lower surface, the method comprising:
(a) cutting a blank from a single sheet of material;
(b) forming the blank into a sleeve which substantially conforms to a shape of at least a portion of the outer surface of the flower pot; and
(c) fixing the sleeve in a formed state;
wherein the sleeve in the formed state is configured to envelope at least a portion of the outer surface of the flower pot such that substantially no portion of the sleeve contacts the lower surface of the pot and no portion of the flower pot directly contacts a substantially flat support surface underlying the sleeve and the pot therein.

17. A method according to claim 16 wherein forming the blank into a sleeve comprises forming the blank into a substantially frusto-conical shape corresponding to an inverted frusto-conical outer shape of a flower pot.

18. A method according to claim 16 wherein cutting a blank from a single sheet of material includes cutting a plurality of decorative cutouts in the blank.

19. A method according to claim 16 wherein the single sheet of material is metal.

20. A method according to claim 19 wherein cutting the blank includes punching or stamping the blank from the sheet of metal.

21. A method according to claim 19 wherein cutting the blank includes laser cutting or abrasively cutting the blank from the sheet of metal.

22. A method according to claim 19 wherein cutting the blank includes machining the blank from the sheet of metal.

23. A method according to claim 19 wherein fixing the sleeve in a formed state comprises welding, soldering, or brazing portions of the sleeve together at a seam.

24. A method according to claim 16 wherein cutting a blank from a single sheet of material includes cutting a plurality of feet in the blank, wherein the feet are configured to support the sleeve and a pot therein on the substantially flat surface.

25. A method according to claim 16, wherein the sleeve includes at least one surface, the method further comprising applying a decorative or protective finish or a painted design to at least a portion of the surface.
